(19) United States
(12) Patent Application Publication
(10) Pub. No.: US 2010/0040836 A1
(43) Pub. Date: Feb. 18, 2010

(54) METHOD FOR PROVIDING SUB-SURFACE MARKS IN POLYMERIC MATERIALS

(76) Inventors: Shenping Li, Painted Post, NY (US); Ellen M. Kosik Williams, Painted Post, NY (US)

Correspondence Address: CORNING INCORPORATED, SP-TI-3-1, CORNING, NY, 14831, US

(21) Appl. No.: 12/510,360

(22) Filed: Jul. 28, 2009

Related U.S. Application Data
(60) Provisional application No. 61/088,194, filed on Aug. 12, 2008.

(51) Int. Cl. B32B 3/10; B44C 1/22

(52) U.S. Cl. 428/187; 216/65; 156/345.1

(57) ABSTRACT

Disclosed herein are methods for making high-contrast sub-surface marks in transparent polymeric materials using femtosecond, picosecond or nanosecond pulsed fiber lasers. Systems for making sub-surface marks and transparent materials bearing marks made by the methods are also disclosed.

### CROSS REFERENCE TO RELATED APPLICATION

This Application claims the benefit of U.S. Provisional Application Ser. No. 61/088,194, filed Aug. 12, 2008, entitled “Method for Providing Sub-Surface Marks in Polymeric Materials”.

### FIELD

The present invention relates generally to systems and methods for making sub-surface marks in polymeric materials using pulsed laser energy. More specifically, the present invention relates to systems and methods for providing laser markings in transparent polymeric materials where the markings are provided in the body of the polymeric material. Materials marked by the methods are also provided.

### BACKGROUND

The ability to mark polymeric materials during a manufacturing process is desirable. Clean, dark, permanent markings identifying parts, dates, batches, materials, functional characteristics, or even providing decorative markings or company logos are desirable in many applications. Improved methods for marking polymeric material, including transparent polymeric material, are desirable.

### SUMMARY OF THE INVENTION

In embodiments, the present invention provides methods and systems to make sub-surface marks in a transparent polymer material. In embodiments, the transparent polymeric material does not contain additives such as pigments, colorants, dyes, foaming agents or blowing agents, to facilitate the formation of a sub surface mark. In embodiments, the marked transparent polymer material remains unblemished on the surfaces of the material after the mark is introduced into the body of the material. In additional embodiments, the present invention provides a system for providing marks in a transparent polymer material having at least one pulsed laser providing laser energy at a wavelength within a transparency window of the polymer material at a pulsewidth of less than 1 ns, and optionally an optical system structured and arranged to focus the laser at a spot below the surface of the polymer material and a dark mark is formed, while the surface of the material, the top surface and/or the bottom surface, remains free of blemishes.

In further embodiments, methods are provided for providing pulsed laser energy having a pulsewidth of less than 1 ns to a position below the surface of a transparent polymer material, a sub-surface spot, and forming a dark mark at that position or spot. In additional embodiments, the laser or the polymer material may be moved to form shapes such as lines, letters, numbers, shapes, two-dimensional shapes, three-dimensional shapes, barcodes, logos or other decorations in the polymer material while the surfaces of the material remains substantially free of blemishes.

In embodiments, the transparent polymeric material or workpiece may be of any transparent polymeric material including polystyrene, polycarbonate, polyethylene terephthalic ester, polyphenylene oxide, or cyclic olefin copolymer, as examples. In additional embodiments, the laser may be a femtosecond or picosecond laser, and may be a fiber laser. In embodiments, laser may be a Yb-doped or Er-doped pulse fiber laser. In embodiments, the laser may provide laser pulses at a pulsewidth of less than 500 ns, less than 100 ns, less than 1 ns, less than 500 ps, less than 100 ps, less than 50 ps, less than 20 ps, less than 10 ps, less than 2 ps, less than 500 fs, or less than 100 fs. In additional embodiments, the mark may be a line of at least 3 μm, at least 5 μm, at least 10 μm or at least 30 μm in thickness, and the top surface and/or the bottom surface of the polymeric material or workpiece may remain unaltered, unblemished, or unmarked by the marking treatment. In further embodiments, the top surface or the bottom surface of the polymer material may have a layer of transparent material, having a complimentary transparency window.

In additional embodiments, the present invention also provides methods for making marks in polymeric material including the steps of: (1) providing a transparent polymer workpiece having a top surface, wherein the workpiece has a transparency window; (2) providing at least two pulsed lasers having a wavelength within the transparency window of the polymeric material; (3) providing laser energy to a sub-surface spot in the polymeric material; and optionally (4) moving the polymeric material in relation to the laser, or moving the laser in relation to the polymeric material, to provide two-dimensional or three-dimensional markings in the polymeric material. In additional embodiments, the invention provides heating the polymer workpiece or polymeric material to a temperature of between 30° C. and 60° C. before applying the laser energy. In additional embodiments, the invention provides cooling the workpiece or polymeric material during the marking step using a cooler which can be, for example, a fan or a heat sink. In additional embodiments, the invention provides heating or cooling a surface or surfaces of the workpiece or polymeric material during the marking step using a heater or cooler which can be, for example, a fan or a heat sink.

### BRIEF DESCRIPTION OF THE DRAWINGS

The invention is best understood from the following detailed description when read with the accompanying drawing figures.

FIG. 1 is a diagram illustrating a pulsed laser beam focused by an optical system on a polymeric workpiece.

FIG. 2 is a graph showing a transmission spectrum of and some transparency windows for one polymeric material, polystyrene.

FIG. 3 is a diagram illustrating that multiple lasers may be focused in the workpiece.

FIG. 4 is another diagram illustrating that multiple lasers may be focused in the polymeric workpiece.

FIG. 5 is an additional diagram illustrating that multiple collimated beams may be crossed in the workpiece.

FIGS. 6A and B are illustrations of heaters or coolers that may be used in embodiments of the present invention.

FIGS. 7A and B are illustrations of heaters or coolers that may be used in embodiments of the present invention.

FIG. 8 is a flowchart showing an embodiment of a method of the present invention.

FIG. 9 is a flowchart illustrating a laser system used to make markings in embodiments of the present invention.

FIG. 10 is a photograph of a polymeric material bearing a sub-surface mark according to embodiments of the method of the present invention.

FIGS. 11A and 11B are photographs showing the sub-surface markings on a polymeric material according to embodiments of the method of the present invention, taken from the top (FIG. 11A) and side (FIG. 11B), in cross-section.

FIG. 12 is a photograph of a polymeric material marked according to embodiments of the method of the present invention.

FIGS. 13A, 13B and 13C are photographs of polymeric materials marked according to embodiments of the method of the present invention, where the laser was pulsed at the repetition rates of 73.6 kHz, 1.18 MHz and 18.84 MHz, respectively.

FIGS. 14A, 14B and 14C are photographs of polymeric materials marked according to embodiments of the method of the present invention, where the laser was pulsed at the pulse-widths of τ=0.83 ps, τ=10 ps and τ=33 ps, respectively.

FIG. 15 is a graph showing the relationship between line width of the markings made in polymeric material and energy in according to embodiments of the present invention.

### DETAILED DESCRIPTION

Embodiments of the present invention relate generally to a system for making sub-surface marks in polymeric materials using pulsed laser energy. More specifically, embodiments of the present invention relate to systems for making high-contrast markings in polymeric material, including a pulsed femtosecond, picosecond or nanosecond laser, optionally an optical system to provide the laser energy to a spot within a polymeric material. In embodiments, methods for providing high-contrast markings in a polymeric material where the markings are internal to the polymeric material are provided. Further, in embodiments, marking methods of the present invention provide that the polymeric material does not contain layers of contrasting material, layers of colorable material, contrasting layers, pigments, foaming agents, metallic, reflective, or other laser energy absorbing materials or additives which are linear absorbers within the transparency window of the polymeric material. In embodiments, the polymeric materials that are marked according to embodiments of the methods of the present invention do not have additives which absorb the applied laser energy to form a dark mark. Rather, the dark mark is made by the application of pulsed laser energy, without the aid of laser energy absorbing additives in the polymeric material to facilitate the formation of sub surface dark marks in the polymeric material. In further embodiments, articles marked by the method are also provided.

In the following detailed description, for purposes of explanation and not limitation, exemplary embodiments disclosing specific details are set forth in order to provide a thorough understanding of the present invention. However, it will be apparent to one having ordinary skill in the art that the present invention may be practiced in other embodiments that depart from the specific details disclosed herein. In other instances, detailed descriptions of well-known devices and methods may be omitted so as not to obscure the description of the present invention.

It is useful and desirable to mark many types of polymeric materials. Polymeric or plastic materials may be marked to reflect lot numbers, source codes, bar codes, multi-dimensional bar codes, recycling codes, company names and logos, part numbers, “use by” dates, traceable quality control information, or any other type of marking. It is useful and desirable, for example, to provide sub-surface markings in transparent polymeric material used to form cell culture surfaces in a way that allows the markings to show through the material but does not introduce irregularities or blemishes in the surface of the material, create unwanted debris, introduce toxic materials, or unnecessarily block the transparency of the material.

In general, surface markings have been made on polymeric materials in a number of ways. Ink printing may be used to mark polymeric materials. Printed labels may have an unstable service life. Printed information may be removed from polymeric material under normal handling conditions or upon exposure to solvents. Printing inks may be potential pollutants or contaminants during handling and printing processes, during the working life of the product, and in the waste stream. Molded markings such as raised markings or inset markings may be created. Molded markings may be difficult to see in non-ideal illumination. Additionally, molded markings are typically not machine-readable.

Markings on surfaces of pigmented polymeric materials may be made, for example, by an etching process using a high power continuous-wave (CW) laser or high-energy nanosecond or longer pulse laser light through a linear absorption process. This laser marking process may work only on surfaces and may leave debris. In addition, this laser marking process may result in a low-contrast mark. Because of thermal effects, this marking process often produces damage or blemishes (stresses, bends, folds and/or cracks) around the marked area. This method may not produce contrasting marks. In addition, because of using linear absorption processes, this laser marking process will not work for materials which are transparent to the laser light.

“Blemish” for the purposes of this disclosure means a dark mark, a damaged spot or discolored area visible to the human eye, an indentation, cavity, protrusion, crease, ridge, fold, crack or bend, or an irregularity or a flaw in the planar top or bottom surface that is significant enough to render the surface inoperable for its intended purpose. For example, “free of blemishes” means that the surface does not contain any one of, or combination of: a dark mark, a damaged spot or discolored area visible to the human eye, an indentation, cavity, protrusion, crease, ridge, fold, crack or bend, or an irregularity or a flaw in the planar top or bottom surface that is significant enough to render the surface inoperable for its intended purpose. Slight nonconformities in the plane of the surface may be tolerable, and may not render the surface inoperable for its intended purpose. However, blemishes such as dark marks, damaged spots, discolored areas visible to the human eye, indentations, cavities or protrusions, creases, ridges, folds, cracks, bends or significant flaws in the surface may render the surface unusable for its intended purpose. In cell culture, as one non-limiting illustration of an intended purpose, significant blemishes might render a polymeric surface unusable as a cell culture surface.

For example, laser marking may cause engraving of a surface and may create a circular raised portion around the engraved area. This damage is not desirable for applications requiring a smooth or controlled polymer surface. For example, in cell culture applications, an uneven, engraved surface would lead to an inconsistent cell culture surface which would not be acceptable in this application. These thermal effects, or blemishes, create uneven surfaces that may not be desirable for particular applications.

Dark marks may be produced in or on light-colored or colorless material by adding a laser energy absorbing pigment to a polymer material, and exposing the material to laser energy that is within the wavelength that is absorbed by the pigment material. That is, a laser energy absorbing material such as pigment, colorant, dye, foaming agent, blowing agent, or layer of contrasting material may be added to the polymeric material. The added laser energy absorbing materials may absorb laser energy at the wavelength provided by the laser. The laser energy absorbing material absorbs the laser energy, heats upon exposure to the laser energy, and the heat induces carbonization or charring of the pigment-containing material, creating a dark mark.

Light marks may be created in polymer material by adding laser energy absorbing foaming agents to the polymer material, inducing foaming of the polymer resin due to the heat produced by exposing the added foaming agent in the polymer material to laser energy.

Introducing these laser energy absorbing materials into a polymer material may not be desirable or feasible. These additives may be expensive and therefore less desirable. These added absorbing materials such as pigments, colorants, dyes, foaming agents, blowing agents or layers of contrasting material may be toxic, both as raw materials in a manufacturing process and as ingredients in a final product. For example, if a transparent polymeric material is to be used as a cell culture surface, the introduction of toxic materials to the polymer may create a surface that is toxic to cells in culture. Providing layers of polymer material represents repetitive manufacturing steps, assembly of layers of material, and additional expense. It is advantageous from a cost and process standpoint, as well as from a safety perspective, to be able to laser-mark transparent polymeric materials without adding laser energy absorbing materials such as pigments, colorants, dyes, foaming agents or additives, blowing agents or layers of contrasting material.

It would be advantageous from a cost, process, and product function standpoint, to be able to laser-mark polymer materials, including transparent polymer materials, without additives and without damaging the surface of the polymer material.

In embodiments of the present invention, “transparent polymer” or “transparent polymeric material” means a polymer or polymeric material which has sufficient transparency to the laser wavelength and which does not contain laser energy absorbing additives such as dyes, pigments, contrast agents, blowing agents, foaming agents, metallic or reflective materials or layers of materials which contain these additives. In embodiments, the transparent polymer is any polymer or blend of polymers which does not contain laser energy absorbing additives. In additional embodiments, the transparent polymer is, for example, polystyrene, polycarbonate, polyethylene terephthalic ester, poly(phenylene oxide), cyclic olefin copolymer, or copolymers or blends of two or more polymers. In embodiments, the transparent polymer that is marked according to methods of the present invention is provided without additives that would affect the transparency of the polymeric material to the wavelength of laser energy being used to mark the transparent polymeric material. In embodiments, the transparent polymeric material is free of laser energy absorbing additives.

In embodiments of the present invention, methods for making high contrast marks in transparent polymeric material such as polystyrene, polycarbonate, polyethylene terephthalic ester, poly(phenylene oxide), cyclic olefin copolymer, or other polymers, or copolymers or blends of two or more polymers, or like material, without the need for laser energy absorbing additives such as pigments, colorants, dyes, foaming agents or additives, blowing agents or layers of contrasting material are provided. The invention takes advantage of short femtosecond, picosecond, or nanosecond duration laser pulses which have high energy densities and interact nonlinearly with the polymeric material resulting in multi-photon absorption, creating dark marks. By focusing or crossing these short duration laser pulses at a position below the surface of the polymeric material, a sub-surface or deep mark may be provided, without affecting the top or bottom surface of the polymeric material.

High-contrast marks or dark marks, for the purposes of this disclosure, means marks that are visible to the human eye, and/or machine readable, and are darker than the surrounding material. For example, a high-contrast or dark mark may appear in a transparent polymer material to be a black, brown, purple, blue, green or other high- contrast, dark or colored mark.

Embodiments of the present invention provide a transparent polymeric material having a top surface and a bottom surface and an interior high contrast or dark mark wherein the top surface and bottom surface are free from blemishes, meaning that the top surface and the bottom surface do not have blemishes. In embodiments the transparent polymer is free of laser energy absorbing additives such as pigments, colorants, dyes, foaming agents, blowing agents, or layers of contrasting material. In embodiments, the transparent polymer has a top surface and a bottom surface and an interior high-contrast or dark mark wherein the top surface and bottom surface are free from blemishes and wherein the transparent polymer is free of laser energy absorbing additives such as pigments, colorants, dyes, foaming agents, blowing agents, or layers of contrasting material. In embodiments of the present invention, a mark is introduced into the body of a transparent polymeric material while the top surface of the transparent polymeric material and the bottom surface of the transparent polymeric material are free from blemishes. In embodiments, the dark mark is embedded in the transparent polymer material, while the surface(s) of the transparent polymer material are suitable for a purpose which requires a smooth, unblemished surface.

In embodiments, a single laser source may be used to introduce high-contrast or dark marks into the body of a transparent polymer material. The wavelength of the laser pulses should be within the transparency window of the polymer material. Because the wavelength of the laser pulses are within the transparency window of the polymeric material, individual laser pulses can pass through the polymeric material without affecting the material until the laser energy is focused or crossed with another laser beam to provide sufficient energy to interact nonlinearly with the polymeric material, causing it to carbonize, and leaving a high contrast or dark mark. In additional embodiments, when multiple laser pulses having an appropriate energy are focused at a single spot within the polymeric material, and are timed so that the laser pulses reach the focal spot at the same time, a dark spot may form at the focal spot. Without being limited to a theory, this laser energy, from more than one source, focused at a single spot, may combine to break down the polymeric material. The combination of these laser pulses may create non-linear absorption in the material, causing changes in the polymeric material. The polymeric material may burn or char. The polymeric material may create soot which is trapped inside the locally heated polymeric material to form dark areas or spots. In embodiments of the present invention, the polymeric material itself is free of pigments. In embodiments, the polymeric material is free of colorants. In embodiments, the polymeric material is free of dyes. In embodiments, the polymeric material is free of foaming agents. In embodiments, the polymeric material is free of blowing agents. In embodiments, the polymeric materials is free of layers of material containing any one or more pigments, colorants, dyes, foaming agents or blowing agents.

In embodiments, combinations of short, highly energetic laser pulses induce a photochemical reaction in the polymer in which the material is locally carbonized, resulting in permanent blackening of the lasered area. The blackened features are on the order of 0.1-100 times the size of the laser focus and this size can be tailored for different applications. By moving the polymeric material or workpiece in relation to the focal point of the laser or lasers, or by moving the focal point of the laser(s) in relation to the workpiece, shapes may be provided in the workpiece including lines, curves, two-dimensional geometrical shapes, three-dimensional geometrical shapes, or any other desired shapes or features.

Depending upon the desired use of the marking, thicker markings may be made or thinner markings may be made. For example, for computer-read markings such as bar codes or markings to be viewed under magnification, ultra-thin markings may be included in the polymeric material. For human reading, thicker lines or shapes may be incorporated. Or, spaced lines or multiple thin lines may be introduced into the material. To the human eye, closely spaced lines may be perceived as one darker thicker line. Due to the very short interaction time between the laser pulses and the material, thermal effects such as cracking are minimized. Lines may be made thicker by passing over the marked area multiple times to provide several dark lines in close proximity to each other.

Laser marking of polymers has been demonstrated using, for example CO₂ and YAG lasers. These lasers are not able to provide femtosecond or picosecond pulsewidths. They may be able to provide nanosecond pulsewidths. These processes generally require additives such as foaming agents (or blowing agents), absorbers, colorants, pigments, dyes or the like to achieve a color change sufficient for providing a useful mark. For example, graphite, carbon black, copper-containing compounds, molybdenum oxide, TiO₂-containing compounds, Prussian Blue, pseudobrookite-coated mica or muscovite may be added to a polymer or plastic bulk batch, or may be incorporated as a single or multiple layer into a larger product. Upon exposure to laser energy, for example laser energy generated by a Nd:YAG laser, but the laser may be any type of laser having a wavelength in the wavelength region of high absorption of the pigment used, the pigment may carbonize, creating a mark. (See U.S. Pat. Nos. 5,928,780, 5,977,514 and US. Published Application 2006/0030631 and Japanese laid-open (Kokai) publication No. H05-337659.)

Femtosecond lasers have been used to ablate polymers without discoloration (P. Moreno et al., Femtosecond laser ablation of carbon reinforced polymers, Applied Surface Science:252(2006) 4110-4119) and to create carbon micro-structures from polystyrene (J. Ashcom et al., Femtosecond laser-induced carbonization of polystyrene, Conference on Lasers and Electro-Optics (CLEO): (2001) p. 231). In addition, laser marking devices have been described which introduce marks into polymeric material (US Publication No. 2007/0086822). However, these marks were very light and required a layer of core material or colored material, to increase the visibility of the marks.

In embodiments, the present invention provides methods for using femtosecond, picosecond, or nanosecond laser pulses with high-repetition rates (50 kHz-30 MHz) to make high-contrast (black) sub-surface marks in transparent polymer material, without creating damage to the surface of the material. The polymeric material is transparent to the laser wavelength. In embodiments, these methods do not require colorants. In embodiments, these methods do not require pigments. In embodiments, these methods do not require dyes. In embodiments, these methods do not require foaming agents. In embodiments, these methods do not require blowing agents. In embodiments, these methods do not require layers of contrasting materials or layers of materials containing colorants, dyes, foaming agents or blowing agents.

Fiber pulse lasers are very suitable for generating 50 kHz-30 MHz femtosecond, picosecond and nanosecond pulses. Because of the advantages of fiber lasers: low cost, high stability, high reliability, compact size, and low maintenance, the use of these lasers for embodiments of the present invention are inherently low cost and suitable for use in industrial environments. In addition, since high-repetition-rate pulses are used, these methods can provide high speed marking.

In embodiments, the present invention involves forming a discolored area which forms a visible mark, or dark mark, in the material. In embodiments of the invention, this discoloration of the polymer is localized to the area near the laser focus and the material is transparent to the laser wavelength, therefore marks can be made inside the polymer material without the need for additional material layers. However, the material may have layers of transparent material (material that is not contrasting or material that does not contain pigments, dyes, contrast, or other similar ingredients). For example, a cell culture polymeric material may have a coating of biologically active material such as proteins, peptides, nucleic acids, cell adhesive or cell adhesion resistant material. Or, the polymeric material may be adjacent to or adhered to a layer of glass or other polymeric material. This polymeric material having a layer may be marked according to embodiments of the present invention where the layer is transparent within the transparency window of the polymeric material and does not contain pigments, colorants, dyes, foaming agents, blowing agents, or layers of contrasting material.

In embodiments, the mark is deep to the surface of the transparent polymeric material. That is, the mark is sub-surface. This type of marking is advantageous in several ways. It allows the surfaces of the polymer material to remain intact, without blemishes produced from the laser exposure. It also eliminates debris or contaminants that might result from a surface marking techniques. It allows the surface of the polymer material to be used for a purpose that requires an unblemished surface. For example, a marked polymer material according to methods of the present invention may be used for cell culture. Other uses are also contemplated herein. For example, marked polymer material according to embodiments of the present invention may be used for packaging, electronic and imaging devices that require smooth polymer surfaces, or other applications.

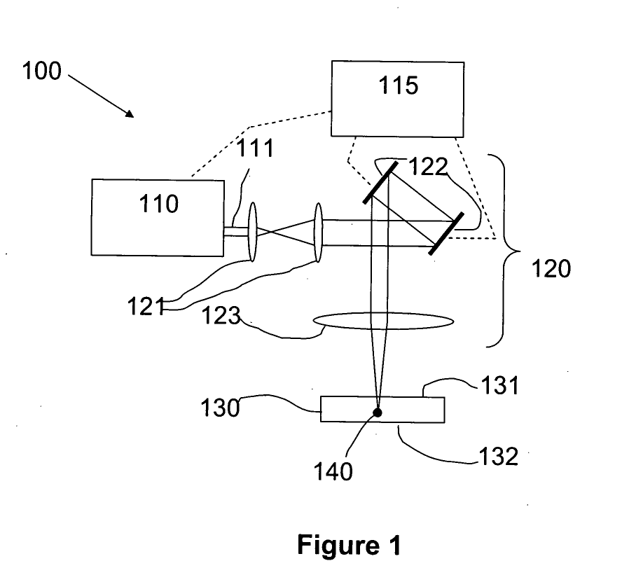

FIG. 1 shows an embodiment of the laser marking system 100 of the present invention using a single pulsed laser beam. The system illustrated in FIG. 1 includes four parts: a pulse laser 110, a controller 115, an optical system 120, which, as illustrated in FIG. 1 including lenses 121, mirrors 122 , a third lens 123, and a workpiece 130 to be marked. The workpiece 130 is transparent polymeric material and has a top surface 131 and a bottom surface 132. (For the purposes of this disclosure the term “workpiece” is transparent polymeric material and the two terms may be used interchangeably.) The laser 110 generates a collimated laser pulse beam 111. The laser pulse beam size is adjusted by lenses 121, and then the direction of the laser beam is controlled by mirrors 122 and focused by another lens 123 to deliver the laser beam to a spot 140. The controller 115 may control the laser 110 and the optical system 120 (as indicated by the dashed lines in FIG. 1). This spot 140 may also be described as a sub-surface mark 140.

In embodiments, the methods of the present invention include using an optical system 120, to provide pulsed laser energy from a single pulsed laser 110 to a particular spot within the polymeric material. These optical systems 120 which may include lenses, mirrors, diffractive optics and polarization optics are well known in the laser art. Particularly when a single laser is used in embodiments of the present invention, the optical system 120 operates to focus the laser energy on a spot 140 within the body of the polymeric material or workpiece.

In embodiments of the present invention, laser 110 may generate short optical pulses. In embodiments, the laser may have the following specifications. The wavelength of the laser pulses should be within the transparency window(s) of the material to be marked. The pulsewidth of the output pulses may be in the femtosecond, picosecond, or nanosecond range. For example, the pulsewidth of the output pulses of the laser is limited only by the physics of the laser and may be less than 1 ns, less than 100 ns or less than 500 ns. Or, the pulsewidth of the output pulses may be less than 1 ns, less than 500 ps, less than 100 ps, less than 50 ps, less than 20 ps, less than 10 ps, less than 5 ps, or any suitable range.

In embodiments, the pulsed laser will have a repetition rate. The repetition rate is the number of pulses per second. The repetition rate of the output pulses of the laser is any value in the range from, for example, 1 kHz to 30 MHz, 20 kHz to 100 kHz, or from 100 kHz to 10 MHz. Fiber pulse lasers are suitable for generating such laser pulses. Higher repetition-rate pulses may allow for more marks per second, which may allow for more markings to be applied to a polymeric material per second. Higher repetition-rate pulses may allow for higher-speed marking.

In embodiments, depending on the duration of the pulses, the energy of the output pulses of the laser may be selected between, for example, 10 nJ to 10 mJ, depending on the needs of the system. For example, if the pulse is of shorter duration, the energy required to create a high-contrast mark in the polymeric material may be decreased. If the pulse is of a longer duration, the energy required to create a high-contrast mark in the polymeric material may be increased. All three of the above-described parameters may be altered to create a laser pulse that has an appropriate pulsewidth, combined with an appropriate repetition rate and sufficient energy to create a sub-surface dark mark in a particular transparent polymeric material for a particular beam size or focusing conditions.

The pulse laser can be any kind of laser which meets the above specifications, including gas lasers, solid-state lasers, semiconductor lasers, or others. For example, TI:Sapphire, YAG, Nd-doped glasses, Yb-doped pulse fiber lasers, Er-doped pulse fiber lasers and CO₂ lasers may be used. Fiber pulsed lasers are suitable for generating 50 kHz-30 MHz femtosecond, picosecond and nanosecond pulses. For example, IMRA μJewel (available from IMRA America, Ann Arbor, Mich.) and Corelase® X-lase® fiber lasers (available from Rofin-Sinar, Plymouth, Mich.) may be used. SpectraPhysics Spitfire (available from Newport, Mountain View, Calif.) may be used to generate femtosecond pulses. In an embodiment, the laser may be a high energy, ultrashort pulse fiber laser such as that disclosed in copending US Publication No. 2008/0025348 or a low-repetition rate ring-cavity passively mode-locked fiber laser as described in copending U.S. application Ser. No. 11/823,680 (both incorporated herein by reference). Fiber lasers are generally low cost, high stability, high reliability, have a compact size, and have low maintenance requirements, making these lasers suitable for use in industrial environments.

Turning again to FIG. 1, in embodiments of the invention, an optical system 120, which can include, for example, a single element lens or multiple element lens system 120, may be used to focus a pulsed laser beam 111 at a focal point or spot 140 inside of the material to be marked. The optical system 120 may also tailor the beam size and shape at the focal point 140.

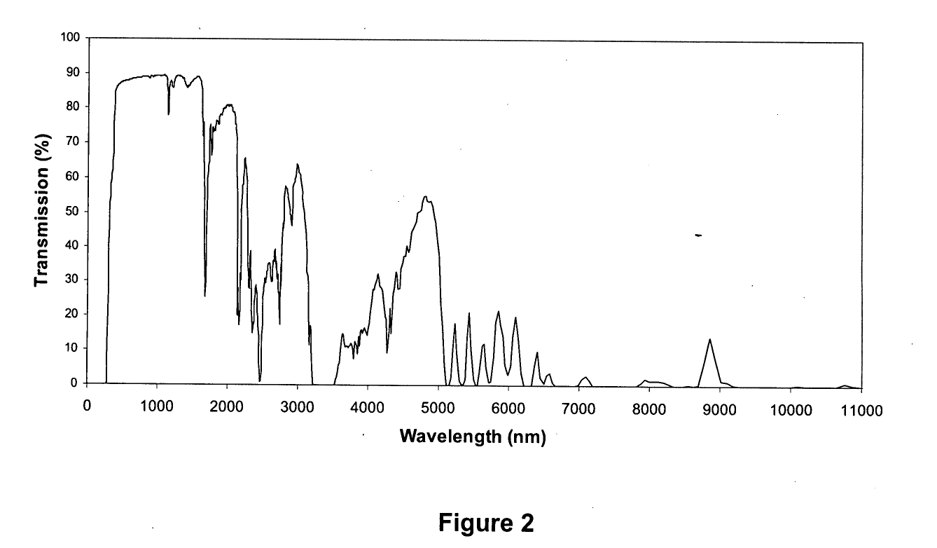

The material to be marked 130 may be plastics or polymers which are transparent for the laser light. FIG. 2 is a graph showing a transmission spectrum, including some transparency windows, for polystyrene, measured from a 1 mm thick piece of polystyrene (Dow 685D). Transparent window (or transparency window), for the purposes of this disclosure, means the range of wavelengths of light that can pass through the material with a useful transmission. For example, the transparency window may be above approximately 60% transmission, above 70% transmission, above 80% transmission or above approximately 90% transmission. In embodiments, lasers generating beams within this range of wavelengths can be used to mark transparent materials. The measurements were taken from a broad band light source from 2500 nm to 200 nm transmittance using a Perkin-Elmer 950 spectrophotometer, with 60 mm diameter integrating sphere, using the following parameters: spectral bandwidth (PMT): 2.0 nm; PbS Servo, Gain: 5; Signal Average Time: 0.5 sec; Scan Speed: 180 nm/min; Detector Change: 850 nm; Aperture: None. The sample was measured for IR transmittance using a Nicolet Nexs 670 FTIR using the following parameters: Scans: 64; Resolution: 8 cm⁻¹; Iris: 30%; Gain: 1; Aperture: 6 mm×19 mm. As shown in FIG. 2, the transparency window for polystyrene (above approximately 60% transmission) is between about 340 nm and about 2100 nm. The transparency window of polystyrene material (above approximately 85% transmission) is from about 390 nm to about 1610 nm.

In embodiments, the material to be marked may be polystyrene, polycarbonate, polyethylene terephthalic ester, or cyclic olefin copolymers, for example, although any transparent polymeric material may be used. The material composition and thickness will affect transparency. For example, in embodiments, the wavelength of light supplied to the material to be marked must be within a transparency window of that material. However, if the material is thick, no transparency window may be measurable, as described and shown in FIG. 2. For example, if the material is 1 m thick, there may be no measurable transparency window for that material. However, if a mark is intended to be made in the first 1 mm of the material, the material may have a suitable transparency window to allow marking, according to embodiments of the present invention. Therefore, in embodiments, the material need only be transparent to the depth of the mark, or the focal point of the laser(s).

In addition, the material may have layers of material on top of or below the polymer to be marked. For example, the polymer material may be coupled to a layer of glass on the top surface or the bottom surface of the polymer workpiece. This will not affect the marking methods of the present invention, as long as the layers of material above the mark are also transparent to the wavelength of energy being provided by the laser.

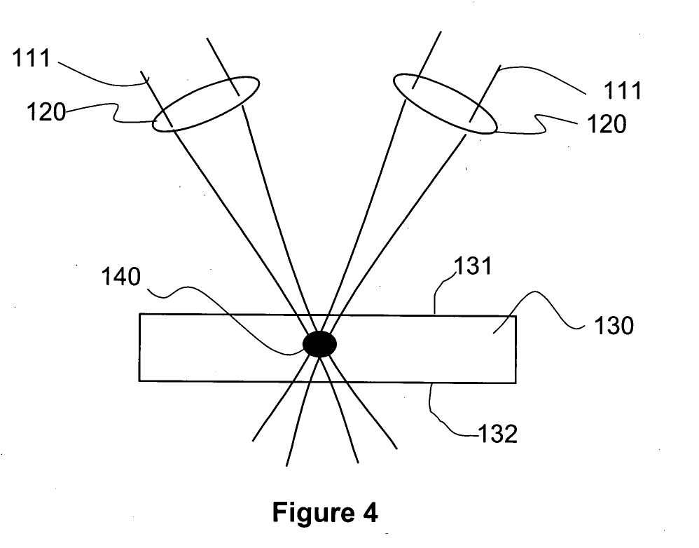

Turning again to FIG. 1, in embodiments, the polymeric material or workpiece 130 may have a top surface 131 and a bottom surface 132 (see also FIG. 4). In embodiments, the laser beam 111 is focused by the optical system 120 at a focal point 140 inside (that is, between the top surface 131 and the bottom surface 132) of the material to be marked. The laser beam 111 is focused on a sub-surface spot or focal point 140. By focusing the laser inside the material, a sub-surface mark may be achieved. As the laser, focused on an interior point or spot 140 of the workpiece, carbonizes the polymer material within the workpiece, dark marks are made at the focal point or spot 140. In embodiments, marking patterns are achieved by either moving the workpiece or moving or scanning the laser focus. By moving the workpiece 130 or the laser in a straight line in relation to each other, for example, a straight line may be achieved as a mark within the workpiece.

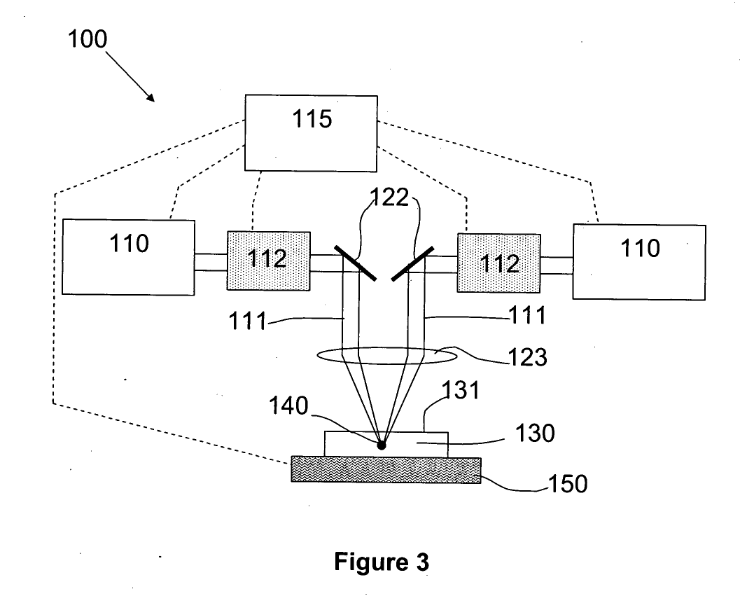

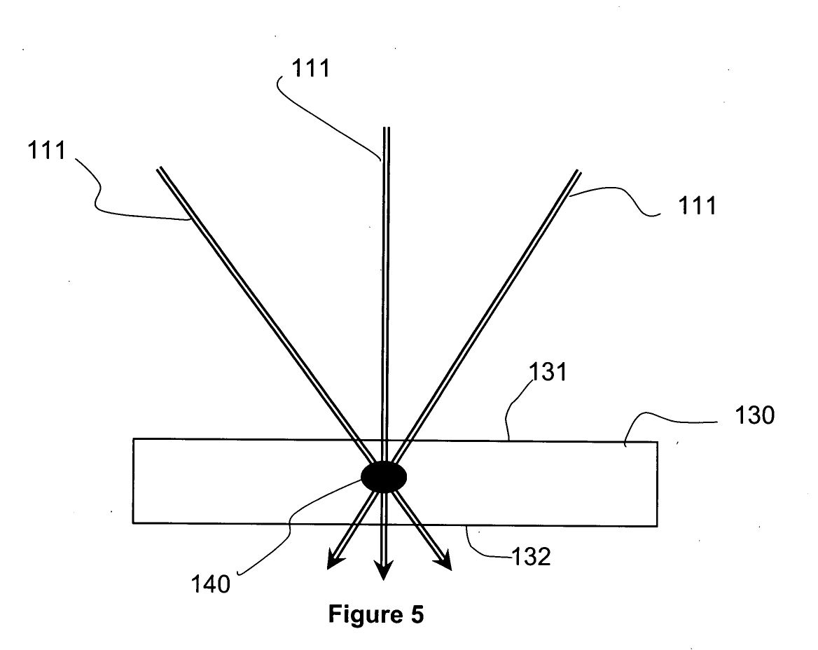

In embodiments of the present invention a method for forming high contrast (black) marks in a transparent plastic or polymer material by using high-repetition-rate (50 kHz-30 MHz) laser pulses with a pulsewidth in femtosecond or picosecond ranges is provided. In embodiments, one laser pulse beam (as shown in FIG. 1), or multiple laser pulse beams are focused ( as shown in FIGS. 3 and 4), or multiple collimated pulse beams are crossed as shown in FIG. 5 at a location between the top surface and the bottom surface of a polymer material. Without being limited by theory, it may be that a black mark is generated at the focal site due to local material carbonization by intense pulsed laser energy.

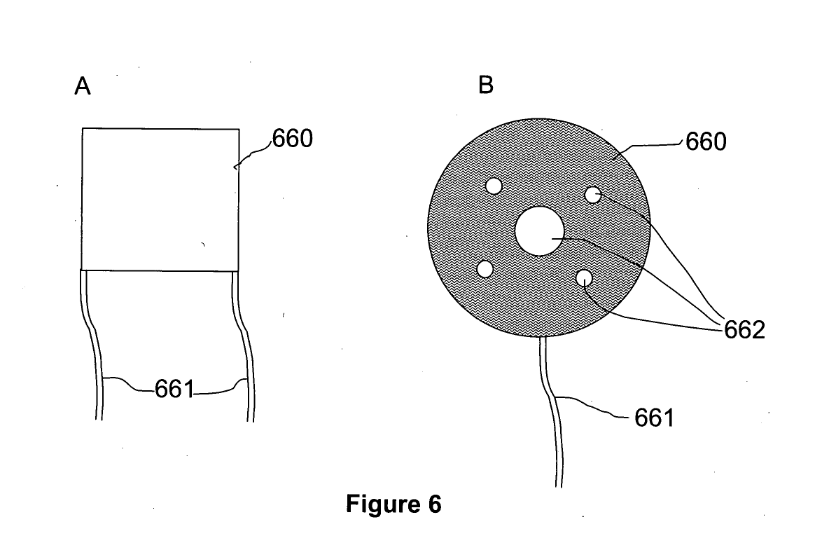

FIG. 3 shows an embodiment of the laser marking system 100 of the present invention using multiple pulsed laser beams. Multiple lasers 110 are shown. The lasers 110 may be controlled by pulse delay systems 112 to make sure that the timing between the pulses is timed correctly so that the beams 111 cross in the workpiece 130 at a spot 140 at the same time. FIG. 3 shows that the workpiece 130 may sit on a stage 150 which is movable to allow for the movement of the workpiece 130 in relation to the focused laser beam(s) 111 to form two dimensional or three dimensional markings in the workpiece 130. In embodiments, the stage may be or may have a heating or cooling device, further described in FIG. 6. A controller 115 may control the lasers 110, the pulse delay systems 112, and the stage 150, as shown by the dashed lines in FIG. 3. Or, in embodiments, separate controllers may control one or more than one of these elements. In addition (not shown) a controller may control the optical system which may have mirrors 122 and lenses 123.

FIG. 4 illustrates that, in embodiments, multiple laser beams 111 may be provided. These multiple beams 111 may focus at the same focal point or spot 140 within the workpiece 130 to create a dark mark 140 in the workpiece 130. These multiple beams may be generated by pulsed lasers, and may provide coordinated pulse energy. That is, the pulses of laser energy may be timed so that pulses are delivered to the focal point at the same time. The laser beams can be generated by a single laser or a number of different lasers. The wavelengths of the lasers may or may not be the same. However, the wavelengths of all lasers should be within the transparency window(s) of the material of the workpiece. In the embodiment illustrated in FIGS. 3 and 4, multiple laser pulse beams 111 are used. Each beam is focused at the same spot 140 of the workpiece 130 by its optical system 120. While the laser intensity of each pulsed beam at the focus may be below the breakdown or nonlinear absorption threshold of the workpiece material individually, the laser intensity of two or more pulsed beams at the focus may be higher than the breakdown or nonlinear absorption threshold of the material. In other words in embodiments, dark marks may be created in the interior of a workpiece more efficiently by focusing two pulse laser beams at the same focal point in the workpiece. In additional embodiments, the pulse position (in time domain) of each beam may be well controlled in order to deliver the pulses of at least two beams to the focus point at the same time. In additional embodiments, by varying the pulse and scanning parameters this method can make large, human-readable marks or very fine, machine readable marks.

The wavelength of the laser pulses is in the transparency window(s) of the materials to be marked. The energy of the individual laser pulses can be delivered to any place inside the polymeric materials by using the optical system to focus the laser pulses. By properly controlling the pulse energy and the pulse duration, the laser intensity only at the focal point can exceed the threshold of the nonlinear absorption (through nonlinear effects, such as two-, or multi-photon absorption) or the breakdown threshold of the materials. This results in the permanent structural change or the carbonization of the material at the focal point. This allows for the formation of high contrast marks inside the bulk material.

The use of high-repetition-rate pulses may be advantageous as it increases the marking volume (or area) without increasing pulse energy. For example, when the repetition rate of the pulses is high enough, multiple consecutive pulses can interact with the material in the same focal area. Without being limited by theory, it may be that a first pulse produces a permanent structural change or carbonization at the focal point, which results in linear absorption in that spot for the following pulses. This affect may lower the light intensity threshold for the surrounding area, thus larger marking area can be achieved. As long as the repetition rate is below the thermal limit, while keeping the pulse energy constant, the higher the repetition rate of the pulses, the higher the marking speed.

FIG. 5 illustrates an additional embodiment of the laser marking system of the present invention. In this embodiment, multiple collimated pulsed laser beams 111 are used. Each beam is crossed at the same marked place 140 of the workpiece 130. In embodiments, the pulse parameters of different pulse beams 111 can be either the same or different from each other. While the laser intensity of each pulsed beam at the marked place may be below the breakdown or nonlinear absorption threshold of the material, the laser intensity of two or more pulsed beams at the marked place may be higher than the breakdown or nonlinear absorption threshold of the material. In other words, in embodiments of the present invention, the use of two or more lasers incident at the same point in the material may increase the efficiency of the marking method. Again, the pulse position (in time domain) of each beam may be well-controlled in order to deliver the pulses of laser energy of two or more beams to the crossing point at the same time. In embodiments, the laser marking system does not require an optical system to focus the beams at a particular spot. For example, where multiple collimated beams are arranged to cross at a spot in the workpiece, that spot may become marked, without specifically focusing the beams at that spot.

In additional embodiments, the polymeric material may be heated to a temperature of between 30° and 60° C. before applying the laser energy. Heating the workpiece may lower the laser energy required to be delivered to the sub-surface spot in order to provide dark or contrasting marks at the desired location in the polymeric material. In additional embodiments, the surface or surfaces of the transparent polymeric material may be cooled to reduce the formation of blemishes at the surfaces of the material.

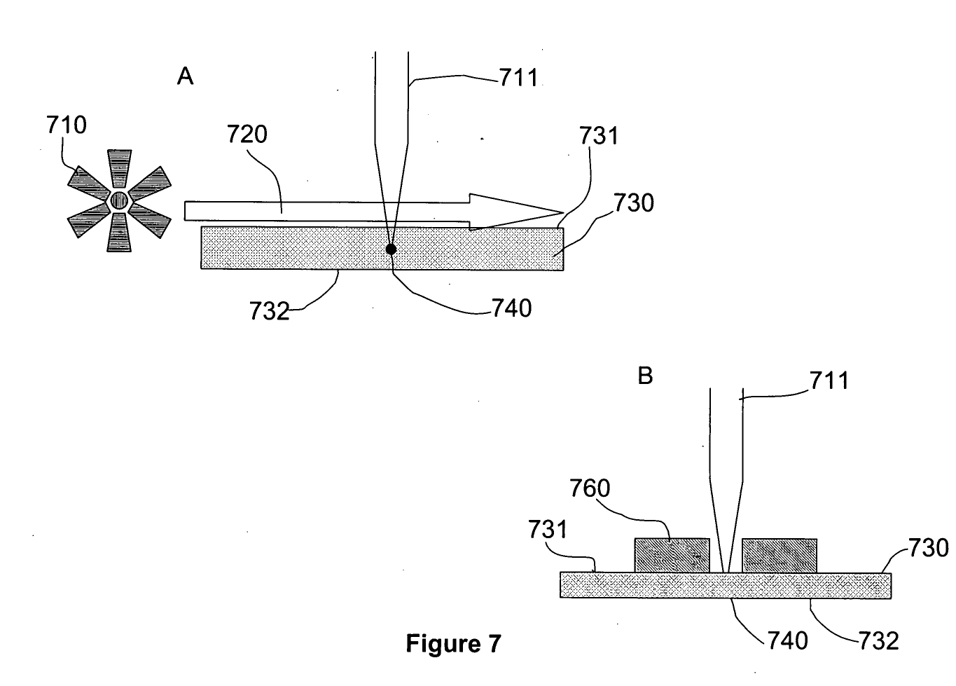

FIG. 6A and 6B illustrate embodiments of surface heaters or coolers of the present invention. As shown in FIGS. 6A and 6B, the surface cooler 660 may be a heat sink, cooling pad or thermoelectric cooler (TEC), the surface heater may also be a TEC. This structure 660 may be a cooling pad or other structure provided below the workpiece adjacent to the bottom surface of the transparent polymeric material (see 150, FIG. 3, where the stage may be a heat sink, or may have a heat sink on top of the stage, under the transparent polymeric material) or adjacent to or on top of the top surface of the transparent polymeric material (see FIG. 7B, where the cooler is a heat sink on top of the transparent polymer or workpiece to be marked). TECs 660 may have power sources provided by connectors 661. In the embodiment shown in FIG. 6B, the TEC 660 may have cut out areas 662 to allow a laser beam to access transparent polymeric material through the top surface of the transparent polymeric material, while the area surrounding the entry point of the laser is cooled by the TEC 660.

FIGS. 7A and 7B further illustrate embodiments of coolers of the present invention. As illustrated in FIG. 7A, the cooler may be a fan 710 which provides a cooling air stream (as illustrated by arrow 720) across the top surface 731 of the workpiece 730 (which also has a bottom surface 732) or the transparent polymeric material 730 as the laser beam 711 is provided to a spot 740 in the transparent polymeric material. FIG. 7B shows a cooler which is a heat sink 760 which has holes (see FIG. 6B) to allow the laser beam 711 to pass through holes of the heat sink 760 to create a spot 740 in the workpiece 730.

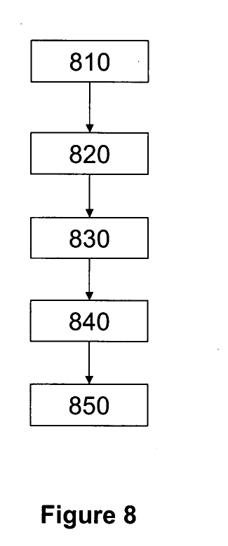

FIG. 8 is a flowchart illustrating steps in the method of the present invention. FIG. 8 shows that the method may include the following steps: (810) provide at least one laser; (820) provide an optical system for each laser to deliver, collimated or focused, the laser beam(s) at a spot to be marked; (830) provide a transparent polymer material; (840) using the optical system, deliver the laser beam (or multiple laser beams) on a point or spot between the top surface and the bottom surface of the polymer material; (850) move either the workpiece or the laser beam(s) to form a mark in the polymer material between the top surface and the bottom surface of the material.

### EXAMPLES

### Example 1

### Marking

Marks were provided in a polystyrene workpiece using a single pulsed fiber laser, as shown in FIG. 1. While marking a polystyrene workpiece is described here, polycarbonate, polyethylene terephthalic ester, polyphenylene oxide, and cyclic olefin copolymer workpieces were also marked. The samples used in experiments were polystyrene (Dow 685D) discs with a diameter of 5.5 cm and a thickness of 1.1 mm. The sample was held on a three axis translation stage. One of the perpendicular axes was motorized, which moved the sample during the marking process. The sample moving speed for all experiments were kept at 1 cm/s. As shown in FIG. 2, the transparency window of polystyrene material (85% transmission) is from 390 nm to 1610 nm. A Yb-doped pulsed fiber laser system, as described below, was used. The center wavelength of the pulses was 1043 nm which is within the transparency window of polystyrene material.

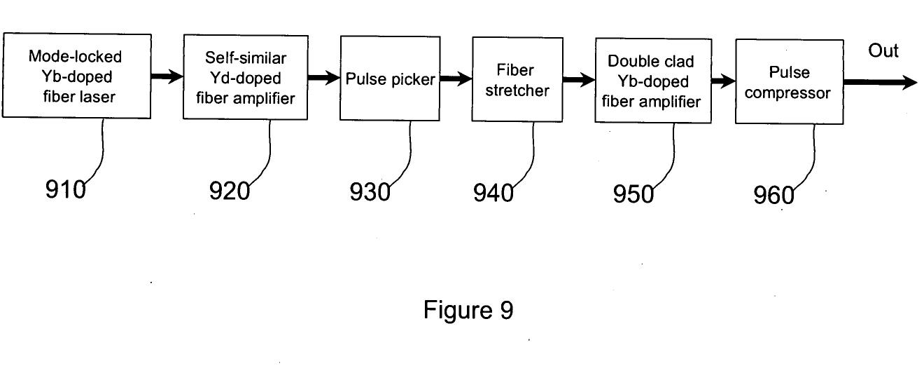

The pulsed fiber laser system is illustrated in FIG. 9 and consists of a mode-locked Yb-doped fiber laser 910, a self-similar fiber amplifier 920, a pulse picker 930, a fiber pulse stretcher 940, Double clad Yb-doped fiber amplifier 950 consisting of a single-mode (SM) Yb-doped fiber pre-amplifier, a double clad Yb-doped fiber pre-amplifier and a double clad Yd-doped fiber power amplifier, and a bulk pulse compressor 960. This system was used throughout the examples presented.

The seed laser 910 was a passively mode-locked Yb-doped fiber ring laser (for details, please refer to copending U.S. patent application Ser. No. 11/823,680). The laser can generate 18.8 MHz pulses with a center wavelength of 1043 nm, a 3 dB spectral bandwidth of 0.5 nm, and a pulsewidth of 5.5 ps (full width at half maximum). The self-similar amplifier 920 was a bi-directional pumped fiber amplifier using low Yb-doped optical fiber. The self-similar fiber amplifier is a SM Yb-doped fiber amplifier with a bi-directional pump configuration. The Yb-doped fiber used in the amplifier is 12 m low Yb-doped SM fiber with an absorption of 95 dB/m at 976 nm, and mode field diameter of 6 μm. The 12 m Yb-doped fiber is pumped from both sides by respectively two 975 nm diode lasers through two wavelength-division-multiplexer (WDM). The self-similar amplifier was used to broaden the spectrum of the input optical pulses through self-similar amplification. In this process, the pulses are linearly chirped, and the 3 dB spectral width of the pulses is broadened from 0.5 nm to about 10 nm.

After the self-similar amplifier, the pulses were launched to a pulse picker 930 which is a fiber pigtailed acousto-optic modulator with a rise time of 18 ns. The repetition rate of the pulses can be discretely changed from 18.8 MHz to any one of the frequencies of 18.8/n MHz (n positive integral). Then, the pulses are stretched at the fiber stretcher 940 by using 1 km standard SM fiber.

After stretching, the pulses were amplified in the three-stage fiber amplifier 950. The pulses were first amplified by a SM Yd-doped fiber pre-amplifier which is formed by 1 m Yb-doped fiber with an absorption of ˜250 dB/m at 975 nm, a WDM and a 975 nm diode laser. The Yb-doped fiber is forward pumped by the diode laser. Then, the pulses are amplified by a double clad Yb-doped fiber pre-amplifier which consists of a 975 nm diode laser, a pump combiner, 4 m double clad Yb-doped fiber. At the input side, the pump combiner combines the pump and signal lights into the Yb-doped fiber. The double clad Yb-doped fiber has a core diameter of 15 μm, a clad diameter of 130 μm, and a cladding absorption of 6.0 dB/m at 975 nm. The last stage amplifier was a double clad Yb-doped power amplifier which is composed of a 976 nm pump diode laser, 2 m double clad Yb-doped fiber, a dichroic mirror, an optical isolator, and four optical lenses. The pump diode laser, which can delivery 976 nm light with a power up to 200 W, was pigtailed with a multimode fiber with a core diameter of 400 μm. The double clad Yb-doped fiber had a core diameter of 30 μm, a clad diameter of 250 μm, and a cladding absorption of 15.5 dB/m at wavelength 976 nm. The dichroic mirror was high transparent in the wavelength range around 975 nm (transmission >99%) and high reflection in the wavelength range around 1045 nm (reflectivity >99%). The focal length and numerical aperture (NA) of lens 1 and 3 are 15.1 mm and 0.625, respectively. The focus length and numerical aperture (NA) of lens 2 are 23.0 mm and 0.385, respectively. The focus length and numerical aperture (NA) of lens 4 are 30.9 mm and 0.294, respectively. Lens 1, and 2 have anti-reflection (AR) coating for wavelengths around 1055 nm. Lens 3 has AR coating for both wavelengths 975 nm and 1055 nm, and lens 4 has AR coating for wavelength 975 nm.

Finally, the pulses were compressed by a bulk pulse compressor 960. The bulk pulse compressor consists of a pair of Grisms and a reflection mirror. Each Grism is composed of a diffraction grating with a groove density of 1740 lines/mm and an equilateral prism with 60 mm long each side, in which the diffraction grating is physically contacted one side of the prism. This pulse fiber laser system can generate pulses with a pulse energy up to 20 μJ. The pulse repetition rate can be adjusted from 18.8 MHz to any one of the frequencies of 18.8/n MHz (n positive integrate). The pulsewidth can be continuously tuned from ˜700 fs to ˜35 ps.

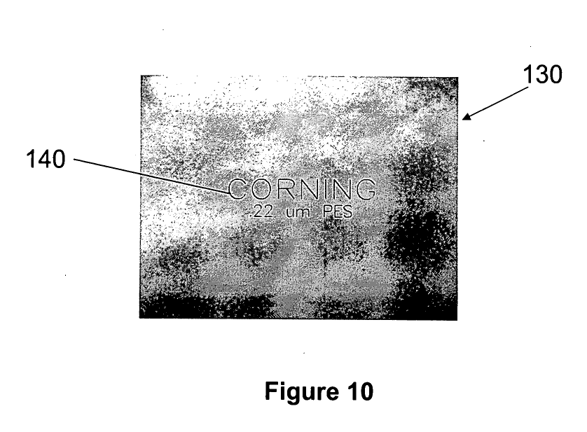

FIG. 10 shows a photograph of one polystyrene sample 130 which was marked using a single Yb-doped pulsed fiber laser at 5.2 ps pulses with a repetition rate of 1.18 MHz and pulse energy of 1.17 μJ. The letters (CORNING, 0.22 um PES) 140 were marked inside of the sample without affecting either the top surface or the bottom surface of the polymeric material. That is, the top surface and the bottom surface were unblemished. The plate was roughly 5.5 cm in diameter and was backed by a piece of white paper to create the photograph. The laser-marked lines are clearly discernable to the naked eye.

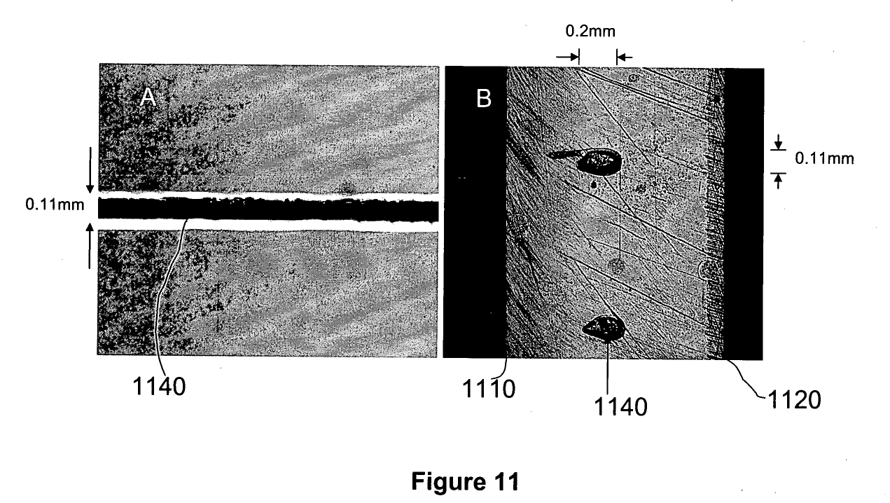

FIGS. 11A and 11B show top view (FIG. 11A) and side view images (FIG. 11B) of a laser marked line 1140 inside a polystyrene sample. This line was marked by using 2.5 μJ, 7 ps pulses with a repetition of 0.58 MHz. FIG. 11B clearly indicates that the 0.11 mm wide line was marked inside the sample and no damage was produced out of the focus volume or at either the top surface 1110 or bottom surface 1120 of the polymeric material. The width and depth of the marked line 1140 were 0.11 mm and 0.2 mm respectively. The scratches visible in FIG. 11B are artifacts of cutting the polymeric material and are not surface blemishes.

### Example 2

### Repetition Rates

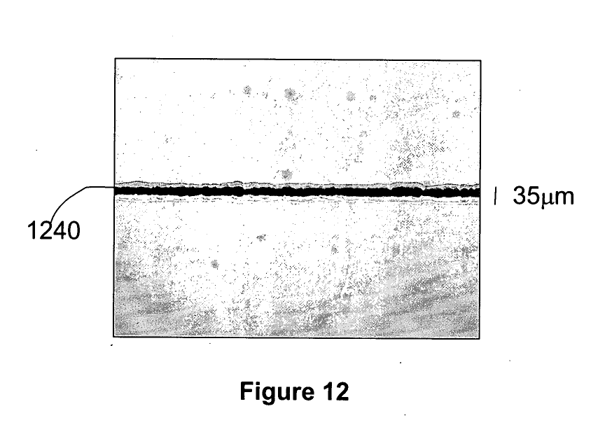

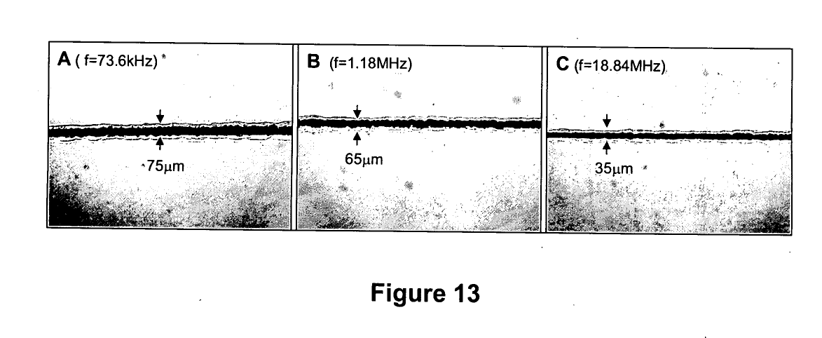

Laser markings of polystyrene samples using laser pulses with different pulse repetition rates were investigated. It was found that the threshold energy of the pulses for breakdown of the polystyrene material was about 60 nJ for pulsewidths near 1 ps. FIG. 12 shows the image of one laser marked line 1240 using 60 nJ, 1 ps pulses with a repetition of 18.84 MHz. It was found that the laser marked lines could be made inside the samples using the pulses within a range of repetition rates. FIG. 13A-C show the images of three laser marked lines respectively using pulses with three different repetition rates: 73.6 kHz (FIG. 13A), 1.18 MHz (FIG. 13B), and 18.84 MHz (FIG. 13C). The pulsewidth and energy of the 73.6 kHz pulses were 4.3 ps and 1.9 μJ, respectively. The pulsewidth and energy of the 1.18 MHz pulses were 2.1 ps and 1.0 μJ, respectively. The pulsewidth and energy of the 18.84 MHz pulses were 1 ps and 60 nJ, respectively. In each case, the material was moved in relation to the laser source at a speed of 1 cm/s. As can be seen in FIG. 13, by varying the repetition rates, the pulsewidth and the energy of the pulses, similar marks can be produced in the polystyrene material.

### Example 3

### Pulsewidth

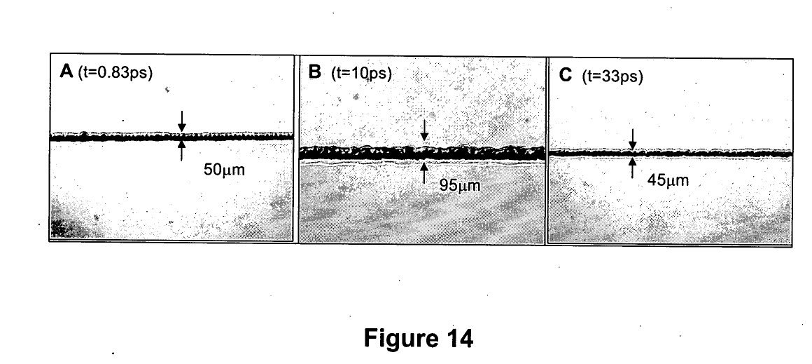

It was found that sub-surface lines could be made in the samples using the pulses within a range of pulsewidths. FIG. 14 shows the images of three laser marked lines respectively using the pulses with three different pulsewidths: 0.83 ps (FIG. 14A), 10 ps (FIG. 14B), and 33 ps (FIG. 14C). The repetition rate and energy of the 0.83 ps pulses were 9.42 MHz and 0.16 μJ, respectively. The repetition rate and energy of the 10 ps pulses were 73.6 kHz and 3.1 μJ, respectively. The repetition rate and energy of the 33 ps pulses were 147.5 kHz and 2 μJ, respectively. Again, by varying the pulsewidths, the repetition rates and the energy of the pulses, similar marks can be produced in the polystyrene material.

### Example 4

### Laser Pulse Energy

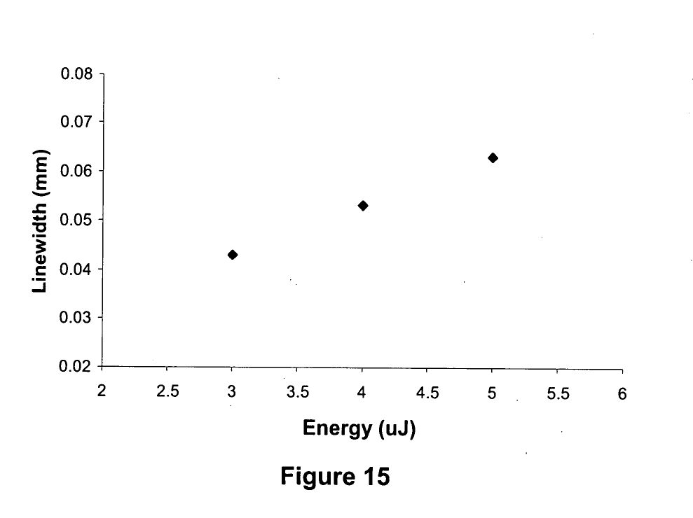

The effect of laser pulse energy (or average power) on the marked line width was investigated. FIG. 15 shows the experimental result. When the energy (or average power) of the pulses was changed, the pulsewidth and the repetition rate of the pulses were kept at 3.6 ps and 0.29 MHz respectively. FIG. 15 shows that the linewidth was linearly proportional to the pulse energy (or average power).

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

1. A marked transparent polymer comprising a transparent polymeric material having a top surface and a bottom surface and a mark in the transparent polymeric material between the top surface and the bottom surface wherein the top surface and bottom surface are free of blemishes.

2. The marked transparent polymer of claim 1 wherein the mark comprises at least one line with a width greater than 1 μm.

3. The marked transparent polymer of claim 1 wherein the marked transparent polymer comprises polystyrene, polycarbonate, polyethylene terephthalic ester, poly(phenylene oxide), or blends of any two or more of these polymers.

4. The marked transparent polymer of claim 1 wherein the mark comprises a line, multiple lines, letters, words, numbers, a bar code, a picture, a logo, a two-dimensional mark or a three-dimensional mark.

5. A system for making sub-surface marks in a transparent polymeric material comprising:
a transparent polymeric material having a top surface and a bottom surface, wherein the transparent polymeric material has a transparency window;
at least one pulsed laser providing laser energy at a wavelength within the transparency window of the polymeric material and a pulsewidth of less than 1 ns;
an optical system structured and arranged to provide the laser energy to a sub-surface spot in the transparent polymeric material wherein the sub-surface spot turns dark in response to the laser energy to form a marked transparent polymeric material wherein the top surface and bottom surface of the polymeric material is free of blemishes.

6. The system of claim 5 wherein the transparent polymeric material comprises polystyrene, polycarbonate, polyethylene terephthalic ester, poly(phenylene oxide), or blends of any two or more of these polymers.

7. The system of claim 5 wherein at least one of the pulsed laser is a fiber laser.

8. The system of claim 7 wherein at least one pulsed laser comprises a Yb-doped or Er-doped pulse fiber laser.

9. The system of claim 5 further comprising a stage for holding the transparent polymeric material wherein the stage is moved in relation to the laser to provide a two-dimensional or three-dimensional mark in the transparent polymeric material.

10. The system of claim 5 further comprising a cooler to cool a surface of the transparent polymeric material.

11. The system of claim 10 wherein the cooler is a heat sink structured and arranged to cool the top or bottom surface of the polymeric material.

12. The system of claim 10 wherein cooler is a fan.

13. The system of claim 11 wherein the stage comprises a heat sink.

14. A method for making sub-surface marks in polymeric material comprising:
providing a transparent polymeric material having a top surface, a bottom surface and a transparency window;
using at least one pulsed laser to provide a laser beam having a wavelength within the transparency window of the polymeric material to provide laser energy at a pulsewidth of less than 1 ns to a sub-surface spot in the polymeric material;
wherein a dark mark is formed at the sub-surface spot while the top surface and bottom surface of the polymeric material are free of blemishes.

15. The method of claim 14 further comprising an optical system to focus the pulsed laser beam at the sub-surface spot.

16. The method of claim 14 wherein one pulsed laser is used to provide a laser beam to the sub-surface spot.

17. The method of claim 14 wherein at least two pulsed lasers are used to provide a laser beam to the sub-surface spot.

18. The method of claim 17 wherein the at least two pulsed lasers are timed to provide at least two laser pulses to the sub-surface spot at the same time.

19. The method of claim 14 further comprising moving either the polymeric material or the laser beam to form a two dimensional mark between the top surface and the bottom surface of the polymeric material.

20. The method of claim 14 further comprising moving either the polymeric material or the laser beam to form a three dimensional mark between the top surface and the bottom surface of the polymeric material.

21. The method of claim 14 wherein the polymeric material comprises polystyrene, polycarbonate, polyethylene terephthalic ester, poly(phenylene oxide), or blends of two or more of these polymers.

22. The method of claim 14 wherein the laser pulse repetition rate is between 50 kHz and 30 MHz.

23. The method of claim 14 wherein the laser pulsewidth is less than 1 ns.

24. The method of claim 14 wherein the laser pulsewidth is less than 500 ps.

25. The method of claim 14 wherein the laser pulsewidth is between 0.1 ps and 500 ps.

26. The method of claim 14 further comprising a step of heating the polymeric material to a temperature of between 30° and 60° C. before applying the laser energy.

27. The method of claim 14 further comprising cooling a surface of the transparent polymeric material while applying the laser beam to the transparent polymeric material.
